(19) United States
(12) Patent Application Publication
(10) Pub. No.: US 2005/0142294 A1
(43) Pub. Date: Jun. 30, 2005

(54) Method of applying the coatings from aluminum alloy on cast iron and steel products

(75) Inventors: Sergey Vasilievich Marutian, Moscow (RU); Yuriy Sergeevich Volkov, Moscow (RU)

Correspondence Address: MCKEE, VOORHEES & SEASE, P.L.C., 801 GRAND AVENUE, SUITE 3200, DES MOINES, IA, 50309-2721, US

(73) Assignee: ZAKRYTOE AKTSIONERNOE OBCHESTVO "MEZHOTRASLEVOE JURIDICHESKOE AGENTSTVO "JURPROMKONSALTING", Moscow (RU)

(21) Appl. No.: 10/500,350

(22) PCT Filed: Dec. 25, 2002
(86) PCT No.: PCT/RU02/00555

(30) Foreign Application Priority Data
Dec. 26, 2001 (RU) 2001135068

(51) Int. Cl. B05D 3/00; B05D 1/18

(52) U.S. Cl. 427/299; 427/430.1

(57) ABSTRACT

The invention refers to applying metal, e.g. aluminum, coatings by plunging into the melt and may be used, for instance, for corrosion protection of rolled and other cast iron and steel products. The result in the method of applying the aluminum coatings on cast iron and steel products comprising product surface preparing and consequent plunging the product into the aluminum melt alloyed with zinc and silicon is reached by jet-abrasive preparing of the product and the aluminum melt is alloyed with zinc, silicon, magnesium and tin, while the temperature of the melt is in the range of 660-680° C.

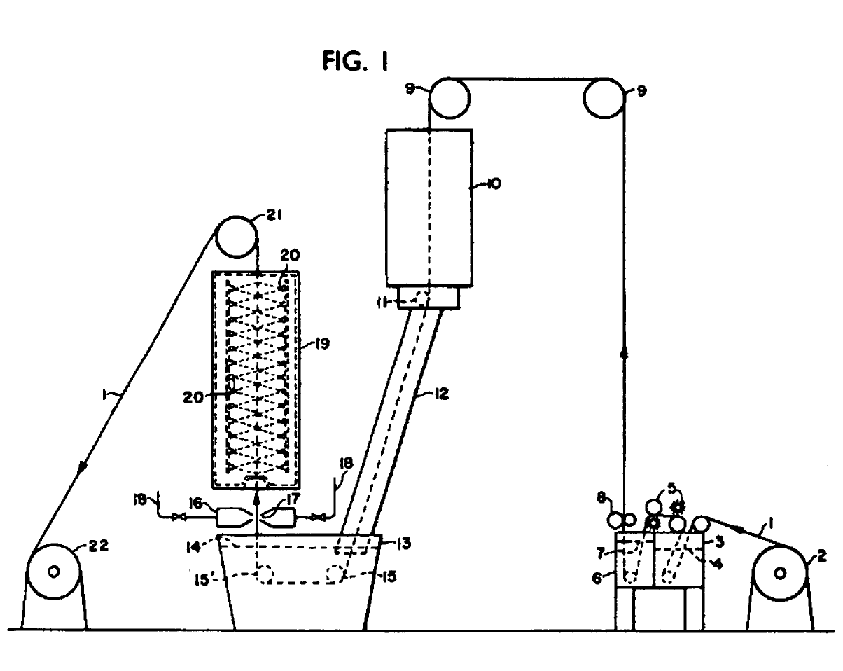

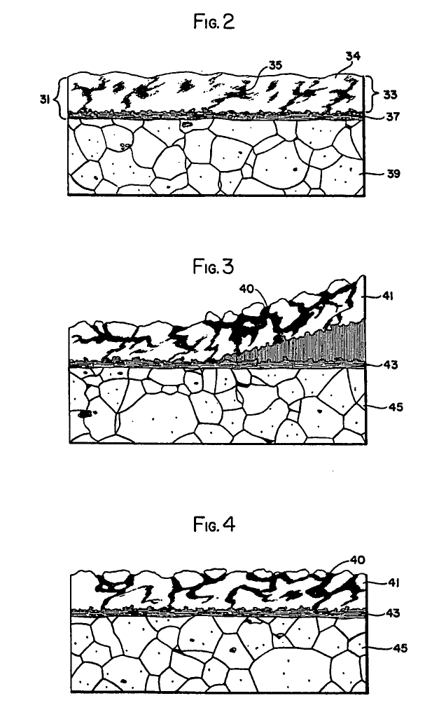

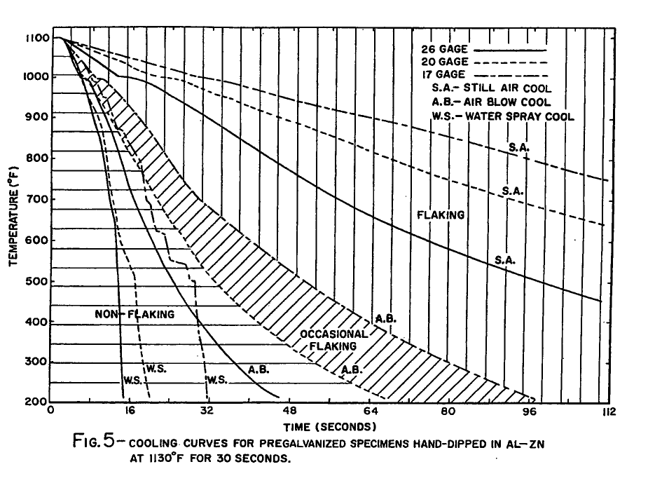

### TECHNICAL FIELD

The invention refers to applying metal, e.g. aluminum, coatings by plunging into the melt and may be used, for instance, for corrosion protection of rolled and other cast iron and steel products.

### BACKGROUND OF THE INVENTION

Methods of applying the aluminum coatings on steel products by plunging into the aluminum melt comprising zinc and magnesium are known.

The closest analog of the present invention is the method of applying the aluminum coatings on cast iron and steel products comprising product surface preparation and consequent plunging the product into the aluminum melt alloyed with zinc and silicon (GB, No 1440328, MPK C23 C1/00,1976).

The disadvantage of the closest analog is impossibility of aluminum melt applying on cast iron and steel products at the temperature lower than 715° C. without using fluxes and the presence of intermetallic compounds of quite a big thickness (10-15 micrometers) make the coating brittle, which doesn't allow to deform the steel product with aluminum coating hereinafter.

### SUMMARY OF THE INVENTION

The present invention solves the problem of decreasing the temperature of aluminum melt, at this temperature the formation of quite a plastic protective coating without using the flux is provided, which allows to deform rolled and other products with aluminum coatings.

In the method of applying the aluminum coatings on cast iron and steel products comprising product surface preparing and consequent plunging the product into the aluminum melt alloyed with zinc and silicon the solution of said problem is reached by jet-abrasive preparing of the product and the aluminum melt is alloyed with zinc, silicon, magnesium, tin of following mass percentage:

| | |
|---|---|
| zinc | 7.0-10.0 |
| silicon | 3.0-5.0 |
| magnesium | 0.5-1.5 |
| tin | 0.2-0.5 |

while the temperature of the melt is in the range of 660-680° C.

The results of applying the aluminum coatings, using jet-abrasive preparing of the surface, in melts of different chemical composition, studying the structure and working qualities of the coatings are presented in Table 1.

Plasticity of the coatings was estimated by testing the pattern on bending around the cylindrical mandrel, while wending on which the coating on the pattern doesn't break. Corrosion qualities of the coatings were estimated according to the results of fast tests of patterns treaded with moisture phase film comprising C1-ion (imitation of the sea atmosphere).

Electrochemical studies of the resulting coating have shown that alloying the aluminum melt, comprising zinc, silicon, magnesium and tin leads to significant increasing in reproducibility of results of electrode potential measurement of the coating, which indicate high uniformity of chemical composition of coating surface layers.

Aluminum coatings were applied on patterns after the jet-abrasive preparing of their surface under different temperature and time regimes by plunging into the melt of the following chemical composition: aluminum—base, zinc—8.0%, silicon—4.5%, magnesium—1.1%, tin—0.4%. The results of the studies if said coatings are presented in Table 2.

The studies have shown that in temperature range of 660-680° C. the formation of thickness uniform aluminum coating without flux using is taking place, this coating is characterized by high corrosion resistance and plasticity.

Analysis of the results of aluminizing in melts of different chemical composition and of different regimes (Tables 1,2) has shown that aluminizing of steel patterns with jet-abrasive preparing of surface in the melt comprising aluminum—base, zinc—7.0-10.0%, silicon—3.0-5.0%, magnesium—0.5-1.5%, tin—0.2-0.5% at the temperature of 660-680° C. leads to the solution of the above said problem. Aluminizing in the proposed melt without flux using and by said regimes provides formation of thickness and structure uniform plastic coatings of high corrosion resistance.

TABLE 1
The main characteristics of aluminum coatings formed in
melts of different chemical composition.

| | | Time of | | Transition | Minimum | |
|---|---|---|---|---|---|---|
| | | exposure in | Coating | zone | diameter of | Character |
| | Temperature | the melt, | thickness, | thickness, | mandrel, | of the |
| Melt composition | of applying, C. | sec | micrometer | micrometer | mm | corrosion |
| Aluminum - base | 720-740 | 40 | 70 | 50 | — | Pit |
| Silicon - 2.0% | | | | | | |
| Manganese - 0.5% | | | | | | |
| Aluminum - base | 730-750 | 70 | 40 | 20 | 20 | Pit |
| Silicon - 7.0% | | | | | | |
| Manganese - 0.5% | | | | | | |
| Aluminum - base | 690-710 | 60 | 50 | 25 | 15 | General, |
| Zinc - 5.0% | | | | | | local |
| Silicon - 2.0% | | | | | | |
| Aluminum - base | 680-700 | 60 | 70 | 20 | 10 | General, |
| Zinc - 7.0% | | | | | | local |
| Silicon - 5.0% | | | | | | |
| Aluminum - base | 670-690 | 70 | 60 | 20 | 10 | General, |
| Zinc - 10% | | | | | | local |
| Silicon - 5.0% | | | | | | |
| Aluminum - base | 660-680 | 70 | 70 | 10 | 10 | General |
| Zinc - 10% | | | | | | |
| Silicon - 5.0% | | | | | | |
| Magnesium - 1.0% | | | | | | |
| Aluminum - base | 660-680 | 70 | 70 | 5 | 10 | General |
| Zinc - 10% | | | | | | |
| Silicon - 5.0% | | | | | | |
| Magnesium - 1.0% | | | | | | |
| Tin - 0.5% | | | | | | |

TABLE 2
The main characteristics of aluminum coatings formed
in the melt of proposed chemical composition.

| | | Time of | | Transition | Minimum | |
|---|---|---|---|---|---|---|
| | Temperature | exposure in | Coating | zone | diameter of | Character |
| Melt | of | the melt, | thickness, | thickness, | mandrel, | of the |
| composition | applying, C. | sec | micrometer | micrometer | mm | corrosion |
| Aluminum - base | 650 | 120 | 80 | 10 | 15 | General |
| Zinc - 8.0% | 660 | 80 | 70 | 5 | 10 | General |
| Silicon - 4.5% | 670 | 70 | 60 | 5 | 10 | General |
| Magnesium - 1.1% | 680 | 70 | 60 | 5 | 10 | General |
| Tin - 0.4% | 690 | 70 | 70 | 10 | 20 | Local |
| | 700 | 70 | 70 | 15 | 25 | Local |
| | 710 | 80 | 90 | 20 | 30 | Local |

1. Method of applying the aluminum coatings on cast iron and steel products comprising product surface preparing and consequent plunging the product into the aluminum melt alloyed with zinc and silicon characterized by jet-abrasive preparing of the product and the aluminum melt is alloyed with zinc, silicon, magnesium, tin of following mass percentage:

| | |
|---|---|
| zinc | 7.0-10.0 |
| silicon | 3.0-5.0 |
| magnesium | 0.5-1.5 |
| tin | 0.2-0.5, |

while the temperature of the melt is in the range of 660-680° C.
